(19) United States
(12) Patent Application Publication
(10) Pub. No.: US 2025/0119772 A1
(43) Pub. Date: Apr. 10, 2025

(54) METHOD AND APPARATUS FOR SIDELINK RADIO LINK FAILURE DETECTION

(71) Applicant: QUALCOMM Incorporated, San Diego, CA (US)

(72) Inventors: Qing LI, Princeton Junction, NJ (US); Hong CHENG, Basking Ridge, NJ (US); Junyi LI, Greentown, PA (US)

(21) Appl. No.: 18/892,915

(22) Filed: Sep. 23, 2024

Related U.S. Application Data
(60) Provisional application No. 63/588,542, filed on Oct. 6, 2023.

(51) Int. Cl. H04W 24/04; H04L 5/00

(52) U.S. Cl. CPC H04W 24/04; H04L 5/001

(57) ABSTRACT

Various aspects of the present disclosure generally relate to wireless communication. In some aspects, a user equipment (UE) may receive a sidelink carrier aggregation configuration including a configuration for sidelink radio link failure (RLF) detection by: selecting one or more sidelink carriers, detecting a sidelink carrier failure associated with a failed sidelink carrier from among the one or more sidelink carriers, and recovering from the sidelink carrier failure in accordance with a reselection of at least one of the one or more sidelink carriers from among one or more candidate sidelink carriers. The UE may transmit a sidelink communication in accordance with the one or more sidelink carriers. Numerous other aspects are described.

### CROSS-REFERENCE TO RELATED APPLICATION

This Patent application claims priority to U.S. Provisional Patent Application No. 63/588,542, filed on Oct. 6, 2023, entitled “SIDELINK RADIO LINK FAILURE DETECTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to methods and apparatuses for sidelink radio link failure detection.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes one or more memories; and one or more processors, coupled to the one or more memories, the one or more processors individually or collectively configured to cause the UE to: receive a sidelink carrier aggregation configuration including a configuration for sidelink radio link failure (RLF) detection to select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers; and transmit a sidelink communication in accordance with the one or more sidelink carriers.

In some aspects, a network node for wireless communication includes one or more memories; and one or more processors, coupled to the one or more memories, the one or more processors individually or collectively configured to cause the network node to: output, to a UE, a sidelink carrier aggregation configuration including a configuration for sidelink RLF detection; receive a sidelink carrier failure report identifying a failed sidelink carrier; and output a downlink signal identifying a sidelink carrier from among one or more available sidelink carriers in accordance with the sidelink carrier failure report.

In some aspects, a method of wireless communication performed by a UE includes receiving a sidelink carrier aggregation configuration including a configuration for sidelink RLF detection by: selecting one or more sidelink carriers, detecting a sidelink carrier failure associated with a failed sidelink carrier from among the one or more sidelink carriers, and recovering from the sidelink carrier failure in accordance with a reselection of at least one of the one or more sidelink carriers from among one or more candidate sidelink carriers; and transmitting a sidelink communication in accordance with the one or more sidelink carriers.

In some aspects, a method of wireless communication performed by a network node includes outputting, to a UE, a sidelink carrier aggregation configuration including a configuration for sidelink RLF detection; receiving a sidelink carrier failure report identifying a failed sidelink carrier; and outputting a downlink signal identifying a sidelink carrier from among one or more available sidelink carriers in accordance with the sidelink carrier failure report.

In some aspects, a non-transitory computer-readable medium storing a set of instructions for wireless communication includes one or more instructions that, when executed individually or collectively by one or more processors of a UE, cause the UE to: receive a sidelink carrier aggregation configuration including a configuration for sidelink RLF detection to select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers; and transmit a sidelink communication in accordance with the one or more sidelink carriers.

In some aspects, a non-transitory computer-readable medium storing a set of instructions for wireless communication includes one or more instructions that, when executed individually or collectively by one or more processors of a network node, cause the network node to: output, to a UE, a sidelink carrier aggregation configuration including a configuration for sidelink RLF detection; receive a sidelink carrier failure report identifying a failed sidelink carrier; and output a downlink signal identifying a sidelink carrier from among one or more available sidelink carriers in accordance with the sidelink carrier failure report.

In some aspects, an apparatus for wireless communication includes means for receiving a sidelink carrier aggregation configuration including a configuration for sidelink RLF detection to select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers; and means for transmitting a sidelink communication in accordance with the one or more sidelink carriers.

In some aspects, an apparatus for wireless communication includes means for outputting, to a UE, a sidelink carrier aggregation configuration including a configuration for sidelink RLF detection; means for receiving a sidelink carrier failure report identifying a failed sidelink carrier; and means for outputting a downlink signal identifying a sidelink carrier from among one or more available sidelink carriers in accordance with the sidelink carrier failure report.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIG. 5 is a diagram illustrating an example of sidelink communications, in accordance with the present disclosure.

FIG. 6 is a diagram illustrating an example of sidelink communications and access link communications, in accordance with the present disclosure.

FIG. 7 is a diagram illustrating an example associated with sidelink radio link failure (RLF) recovery based on an implicit sidelink carrier failure, in accordance with the present disclosure.

FIG. 8 is a diagram illustrating an example associated with sidelink RLF recovery based on an explicit sidelink carrier failure, in accordance with the present disclosure.

FIG. 9 is a diagram of an example associated with sidelink RLF detection and recovery involving a network node, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Techniques such as carrier aggregation can be used in wireless communication to increase a data rate and network capacity by using multiple frequency bands simultaneously. For example, a device using carrier aggregation may combine several carrier bands to create wider channels and thereby increase the bandwidth available for data transmission. Sidelink is a wireless technology that allows device-to-device communication without routing data through a network node. For example, rather than communicating through a network node, sidelink allows a transmitting (Tx) user equipment (UE) to communicate directly with a receiving (Rx) UE using a PC5 link (e.g., a link via the PC5 interface). A sidelink radio link failure (RLF) refers to the interruption or failure in a communication link between devices (e.g., between UEs). When an RLF occurs, the devices may attempt to reestablish communication with one another.

Carrier aggregation techniques can be used to improve the data rate and network capacity of sidelink communications. In the context of sidelink communication, carrier aggregation allows the Tx UE to transmit signals over multiple sidelink carriers selected at the medium access control (MAC) layer, which can make it difficult to detect when the RLF occurs in the PC5 link since the sidelink carrier failure may occur at the MAC layer (e.g., an indication of a maximum number of discontinuous transmissions has been reached), a radio link control (RLC) layer (e.g., a maximum number of retransmissions has been reached), a packet data convergence protocol (PDCP) layer (e.g., an integrity check failure), or a radio resource control (RRC) layer (e.g., a T400 timer has expired).

Various aspects relate generally to sidelink carrier aggregation. More specifically, various aspects relate generally to a PC5 RLF procedure for sidelink carrier aggregation and to PC5 RLF sidelink carrier detection and recovery. In some aspects, a UE, such as a Tx UE, is configured to receive a sidelink carrier aggregation configuration including a configuration for sidelink RLF detection in accordance with sidelink carrier failure detection and attempted recovery. In accordance with the configuration, the UE may select one or more sidelink carriers, detect a sidelink carrier failure associated with a failed sidelink carrier from among the one or more sidelink carriers, and attempt to recover from the sidelink carrier failure by reselecting at least one of the one or more sidelink carriers from among one or more candidate sidelink carriers. If the UE is able to recover from the sidelink carrier failure by reselecting the one or more sidelink carriers from among the one or more candidate sidelink carriers, the UE may transmit a sidelink communication in accordance with the one or more sidelink carriers. If the UE is unable to recover from the sidelink carrier failure, the UE may declare the RLF. In some aspects, a network node is configured to output, to a UE, a sidelink carrier aggregation configuration including a configuration for sidelink RLF detection; receive a sidelink carrier failure report identifying a failed sidelink carrier; and output a downlink signal identifying a sidelink carrier from among one or more available sidelink carriers in accordance with the sidelink carrier failure report.

Particular aspects of the subject matter described in this disclosure can be implemented to realize one or more of the following potential advantages. In some examples, the described techniques can be used to enhance sidelink carrier aggregation. For example, by reselecting one or more sidelink carriers from among one or more candidate sidelink carriers, the UE may transmit sidelink communications that meet quality of service (QOS) requirements. Moreover, by receiving the configuration for sidelink RLF detection, the UE may continue certain sidelink communications without having to declare a sidelink RLF. By receiving a sidelink carrier failure report identifying a failed sidelink carrier, the network node may reselect the sidelink carrier, making the configuration applicable to mode 1 resource allocations.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

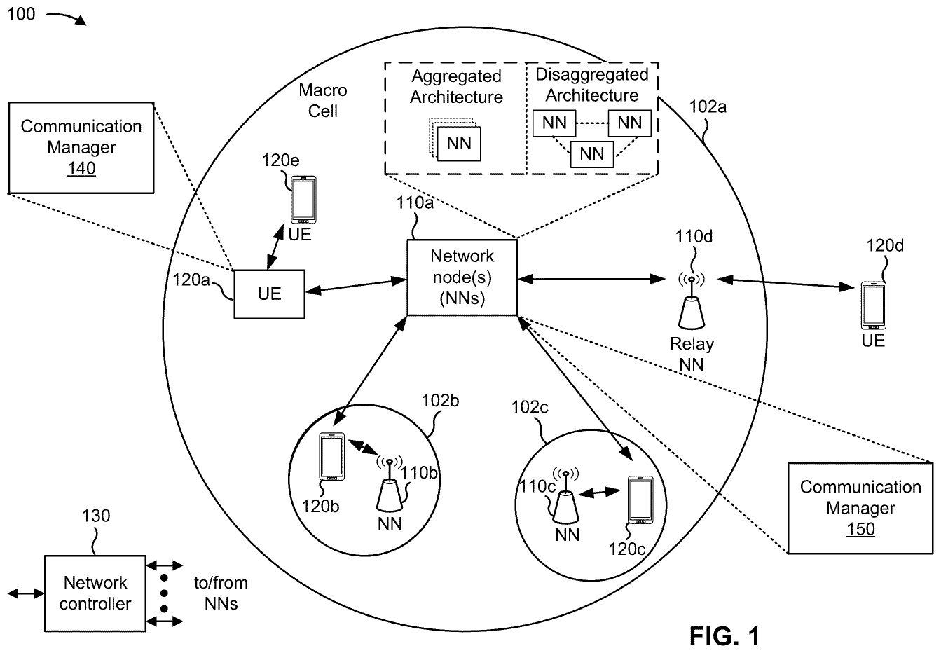

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a sidelink carrier aggregation configuration including a configuration for sidelink RLF detection to: select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers; and transmit a sidelink communication in accordance with the one or more sidelink carriers. Additionally, or alternatively, the communication manager 140 may perform one or more other operations described herein.

In some aspects, the network node 110 may include a communication manager 150. As described in more detail elsewhere herein, the communication manager 150 may output, to a UE, a sidelink carrier aggregation configuration including a configuration for sidelink RLF detection; receive a sidelink carrier failure report identifying a failed sidelink carrier; and output a downlink signal identifying a sidelink carrier from among one or more available sidelink carriers in accordance with the sidelink carrier failure report. Additionally, or alternatively, the communication manager 150 may perform one or more other operations described herein.

As indicated above, FIG. 1 is provided as an example. Other examples may differ from what is described with regard to FIG. 1.

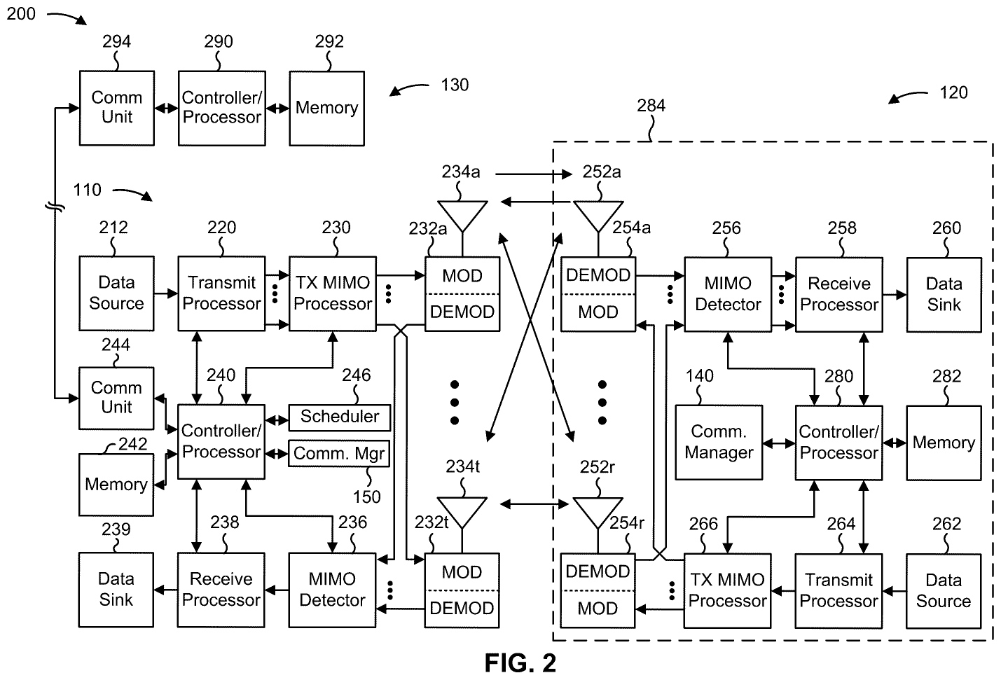

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

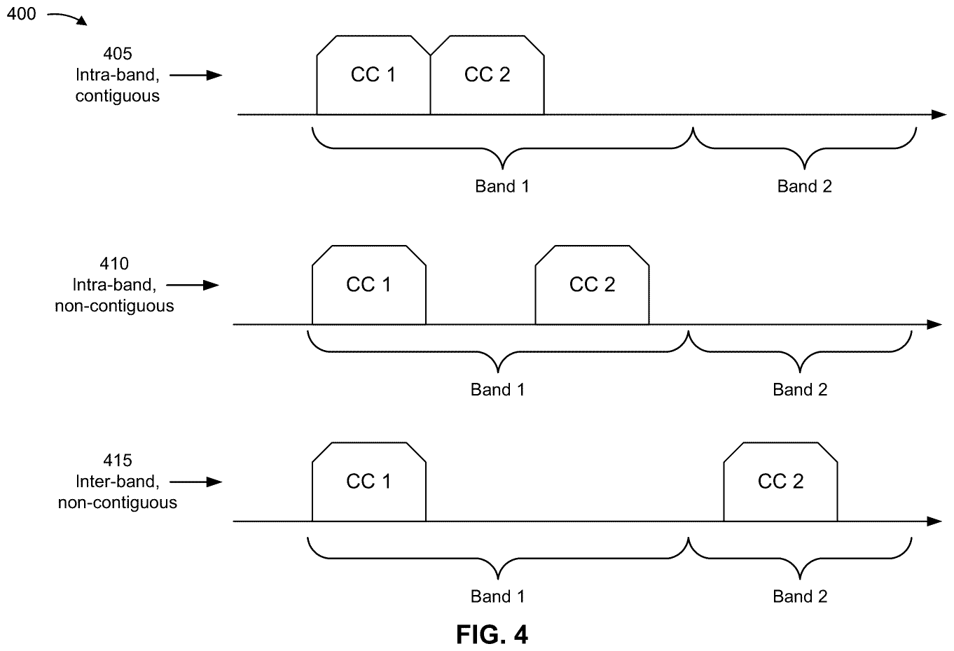

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

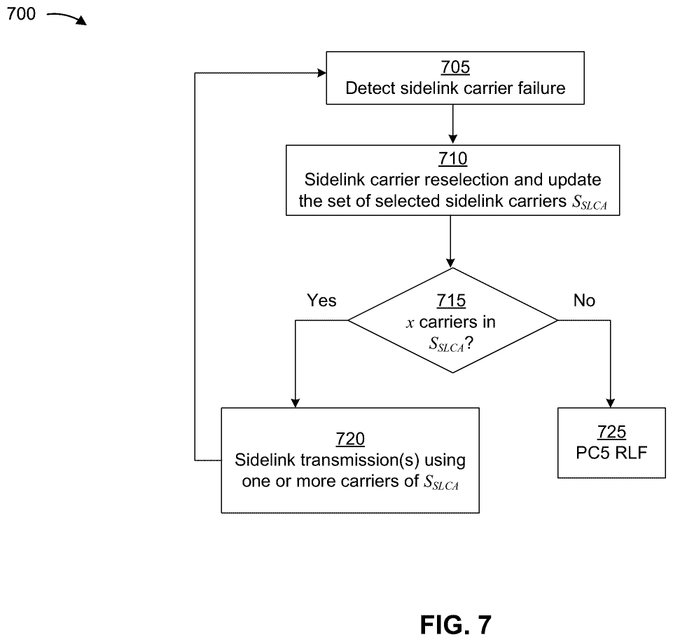

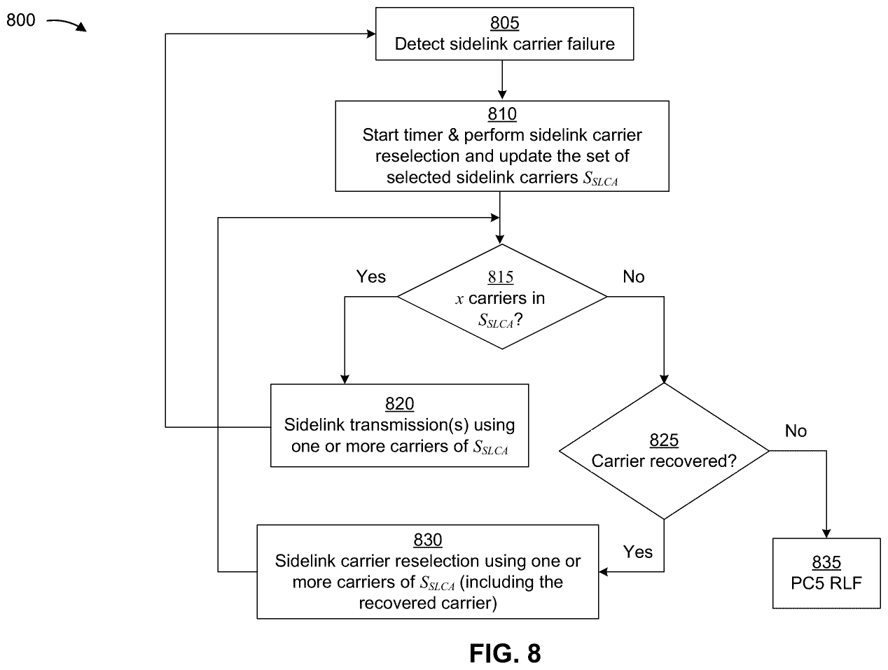

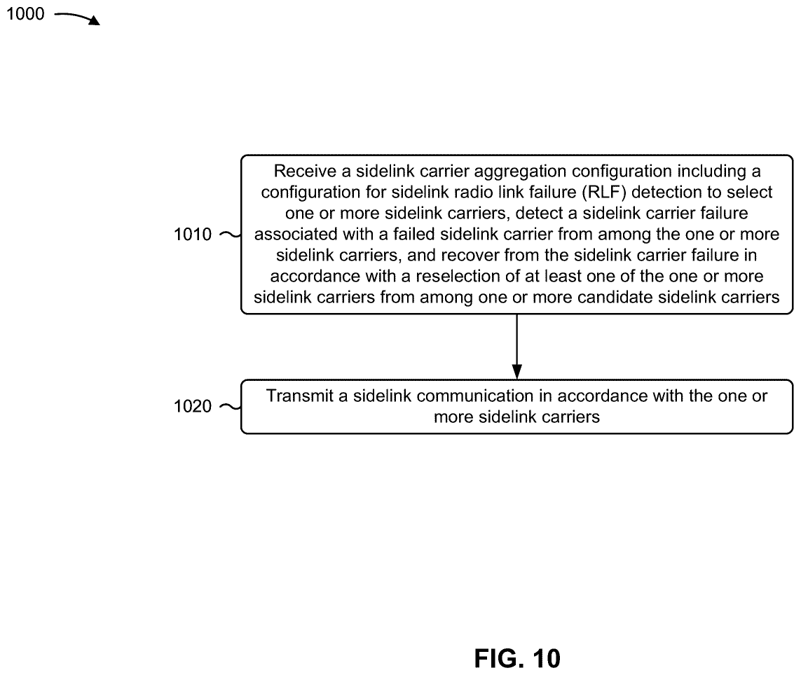

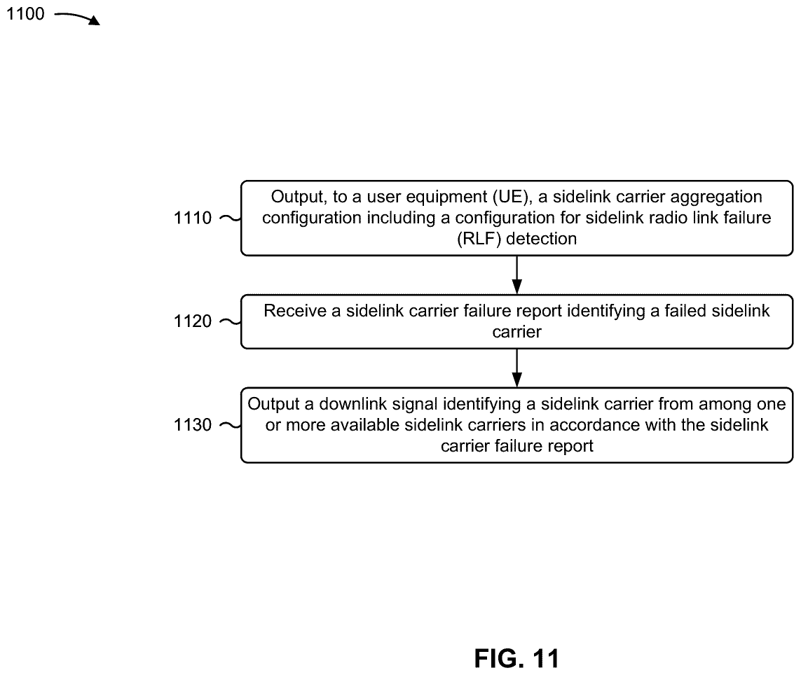

The controller/processor 240 of the network node 110, the controller/processor 280 of the UE 120, and/or any other component(s) of FIG. 2 may perform one or more techniques associated with sidelink RLF detection and recovery, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) individually or collectively by one or more processors of the network node 110 and/or the UE 120, may cause the one or more processors, the UE 120, and/or the network node 110 to perform or direct operations of, for example, process 700 of FIG. 7, process 800 of FIG. 8, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving a sidelink carrier aggregation configuration including a configuration for sidelink RLF detection to: select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers; and/or means for transmitting a sidelink communication in accordance with the one or more sidelink carriers. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for outputting, to a UE, a sidelink carrier aggregation configuration including a configuration for sidelink RLF detection; means for receiving a sidelink carrier failure report identifying a failed sidelink carrier; and/or means for outputting a downlink signal identifying a sidelink carrier from among one or more available sidelink carriers in accordance with the sidelink carrier failure report. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

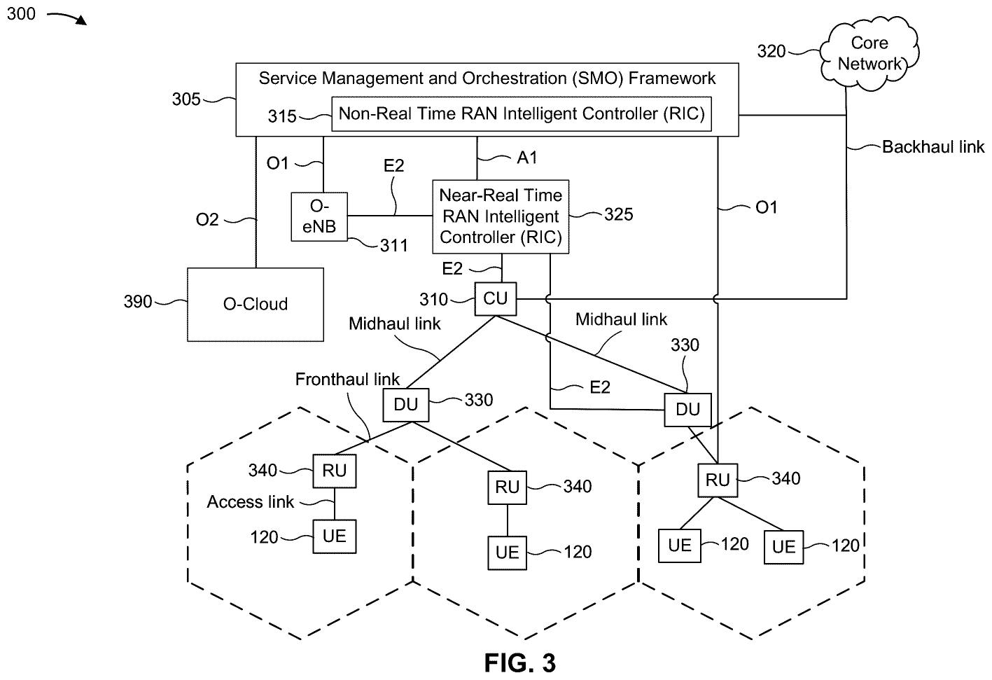

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

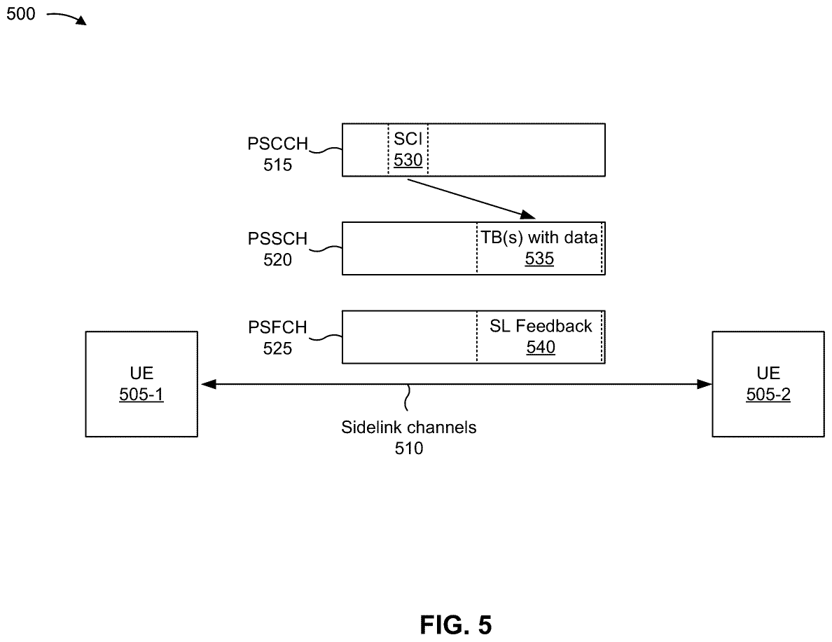

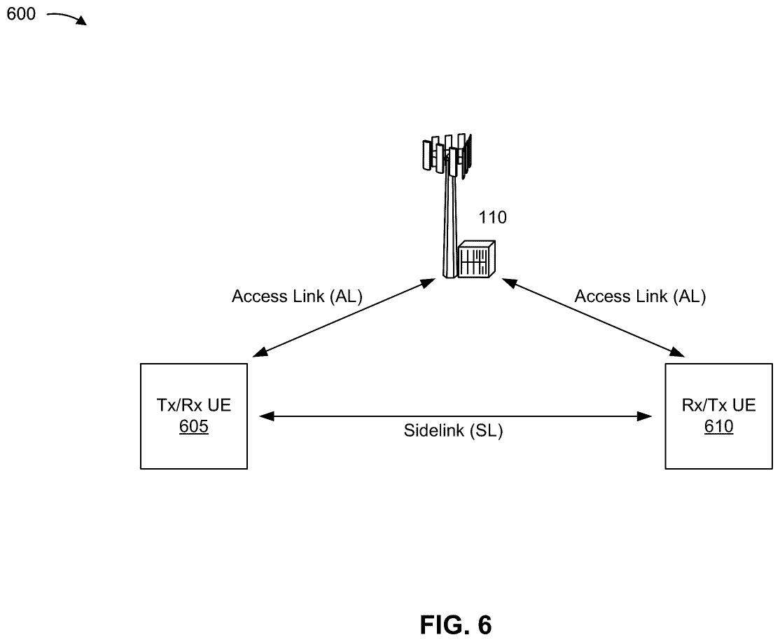

As it relates to sidelink, which is discussed in greater detail below with respect to FIGS. 5 and 6, a Tx UE may be configured with multiple MAC-layer carriers for communicating with one or more Rx UEs. Moreover, some data may be transmitted between the Tx UE and the Rx UE via a PC5 link. Because data is sent via different carriers, certain RLFs, such as an RLF on the PC5 link, may be difficult to detect. The manner in which the Tx UE is configured to handle RLF for sidelink carrier aggregation is discussed in greater detail below with respect to FIGS. 7-9.

As indicated above, FIG. 4 is provided as an example. Other examples may differ from what is described with regard to FIG. 4.

FIG. 5 is a diagram illustrating an example 500 of sidelink communications, in accordance with the present disclosure.

As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for P2P communications, D2D communications, V2X communications (e.g., which may include V2V communications, V2I communications, and/or V2P communications) and/or mesh networking. In some aspects, the UEs 505 (e.g., UE 505-1 and/or UE 505-2) may correspond to one or more other UEs described elsewhere herein, such as UE 120. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a physical sidelink control channel (PSCCH) 515, a physical sidelink shared channel (PSSCH) 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with a network node 110 via an access link or an access channel. The PSSCH 520 may be used to communicate data, similar to a physical downlink shared channel (PDSCH) and/or a physical uplink shared channel (PUSCH) used for cellular communications with a network node 110 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a QoS priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 520, such as a HARQ process ID, a new data indicator (NDI), a source identifier, a destination identifier, and/or a channel state information (CSI) report trigger.

In some aspects, a UE 505 may operate using a sidelink resource allocation mode (e.g., Mode 1) where resource selection and/or scheduling is performed by a network node 110 (e.g., a base station, a CU, or a DU). For example, the UE 505 may receive a grant (e.g., in DCI or in an RRC message, such as for configured grants) from the network node 110 (e.g., directly or via one or more network nodes) for sidelink channel access and/or scheduling. In some aspects, a UE 505 may operate using a resource allocation mode (e.g., Mode 2) where resource selection and/or scheduling is performed by the UE 505 (e.g., rather than a network node 110). In some aspects, the UE 505 may perform resource selection and/or scheduling by sensing channel availability for transmissions. For example, the UE 505 may measure an RSSI parameter (e.g., a sidelink-RSSI (S-RSSI) parameter) associated with various sidelink channels, may measure an RSRP parameter (e.g., a PSCCH-RSRP or PSSCH-RSRP parameter) associated with various sidelink channels, and/or may measure an RSRQ parameter (e.g., a PSCCH-RSRP or PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more slots to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

As indicated above, FIG. 5 is provided as an example. Other examples may differ from what is described with respect to FIG. 5.

FIG. 6 is a diagram illustrating an example 600 of sidelink communications and access link communications, in accordance with the present disclosure.

As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a network node 110 may communicate with the Tx/Rx UE 605 (e.g., directly or via one or more network nodes), such as via a first access link. Additionally, or alternatively, in some sidelink modes, the network node 110 may communicate with the Rx/Tx UE 610 (e.g., directly or via one or more network nodes), such as via a first access link. The Tx/Rx UE 605 and/or the Rx/Tx UE 610 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As discussed above, an RLF on the PC5 link (e.g., a link between a Tx UE and an Rx UE using the PC5 interface) may be difficult to detect when carrier aggregation is used for sidelink communications. The manner in which the Tx UE is configured to handle RLF for sidelink carrier aggregation is discussed in greater detail below with respect to FIGS. 7-9.

As indicated above, FIG. 6 is provided as an example. Other examples may differ from what is described with respect to FIG. 6.

FIG. 7 is a diagram illustrating an example 700 associated with sidelink RLF recovery based on an implicit sidelink carrier failure, in accordance with the present disclosure. The example 700 may be performed by a Tx UE (e.g., UE 120/605) to, for example, detect a PC5 RLF when fewer than a minimum number of sidelink carriers are available based on sidelink carrier selection criteria.

As shown by reference number 705, the Tx UE may detect a sidelink carrier failure based on one or more indications of a possible sidelink RLF. The one or more indications of the possible sidelink RLF may include an indication of reaching a maximum HARQ discontinuous transmission (DTX) occurrences (e.g., which may be a defined or configured value for a carrier or for all carriers associated with a sidelink service) at the MAC layer, an indication of reaching a maximum number of retransmissions (e.g., similarly, which may be a defined or configured value for a carrier or for all carriers associated with a sidelink service) at the RLC layer, an indication of integrity check failure at the PDCP layer, and/or an indication of a timer expiry at the RRC layer for responding a PC5 RRC configuration message. One or more of the indications may be associated with a configuration of the Tx UE, the Rx UE, and/or a combination thereof, among other examples. For example, the indication of the maximum number of retransmissions at the RLC layer may be based, at least in part, on a configuration for handling retransmissions of the data logical channel on a carrier selected by MAC (e.g., as described in connection with reference number 710) for automatic repeat requests (ARQ) with acknowledged mode (AM). The indication of the integrity check failure at the PDCP layer may be based, at least in part, on how signaling radio bearers (SRBs) are transmitted on a carrier (e.g., SRB2 or SRB3 transmitted on a carrier, such as a default carrier or another suitable carrier). The indication of the timer (e.g., a T400 timer) expiry at the RRC level may be based, at least in part, on how an RRC message on a control logical channel is transmitted on a carrier selected by MAC (e.g., as described in connection with reference number 710).

As shown by reference number 710, the Tx UE may reselect one or more sidelink carriers, from among a set of one or more candidate sidelink carriers, and update a set of selected sidelink carriers S_{SLCA}. A sidelink carrier is a communication channel used for UE-to-UE communication (e.g., between the Tx UE and an Rx UE) without routing the communications through a network node 110. The candidate sidelink carriers may include one or more sidelink carriers available for sidelink communication between the Tx UE and the Rx UE. The one or more sidelink carriers in the set of selected sidelink carriers S_{SCLA} may have been previously selected, by the Tx UE, for sidelink communication with the Rx UE. Accordingly, in some aspects, a reselection of the one or more sidelink carriers may include the Tx UE updating the set of selected sidelink carriers S_{SLCA} with one or more candidate sidelink carriers. The set of selected sidelink carriers S_{SLCA} may be used by the Tx UE for sidelink communications. In some aspects, the carrier associated with the sidelink carrier failure discussed above with respect to reference number 705 may be included in the set of selected sidelink carriers S_{SLCA}. For example, for each sidelink carrier configured by upper layers (e.g., including the carrier associated with the sidelink carrier failure) on which a sidelink logical channel (e.g., with data available) is allowed, if the CBR of the carrier is below a threshold for carrier selection associated with the priority of the sidelink logical channel, the carrier is included (by the Tx UE) in the set of selected sidelink carriers S_{SLCA}. In some aspects, the Tx UE may indicate the set of selected sidelink carriers S_{SLCA} to an Rx UE via PC5 RRC message (e.g., for unicast) or to Rx UE(s) via MAC CE, and the Rx UE(s) may then monitor the set of selected sidelink carriers S_{SLCA} for sidelink transmissions.

As shown by reference number 715, the Tx UE may determine if the set of selected sidelink carriers S_{SLCA} includes a minimum number of sidelink carriers for retaining a PC5 link (e.g., avoiding a PC5 RLF). The minimum number of sidelink carriers may be a configured or defined quantity. In some aspects, the minimum number of sidelink carriers may be based, at least in part, on a QoS requirement of the PC5 link. For example, for some sidelink communications, one sidelink carrier may be sufficient to meet the QoS requirements. In that case, the minimum number of sidelink carriers may be one. Alternatively, in some aspects, more than one sidelink carrier may be required to meet the QoS requirements (e.g., multiple sidelink carriers are required for PDCP duplication or MAC duplication based on the QoS and/or channel condition). Examples of QOS requirements that may affect the minimum number of sidelink carriers may include data rate, reliability, latency, and/or a combination thereof, among other examples.

As shown by reference number 720, as a result of determining that the minimum number of sidelink carriers are available (e.g., the minimum number of sidelink carriers are included in the set of selected sidelink carriers S_{SLCA}), the Tx UE may continue to transmit sidelink communications using one or more carriers included in the set of selected sidelink carriers S_{SLCA}. For example, for each sidelink logical channel allowed on the carrier where data is available, the Tx UE may select one or more carrier(s) and associated pool(s) of resources from among the set of selected sidelink carriers S_{SLCA} with increasing order of CBR from the lowest CBR for transmitting sidelink communications, among other examples.

As shown by reference number 725, as a result of determining that the minimum number of sidelink carriers are unavailable (e.g., the minimum number of sidelink carriers are not included in the set of selected sidelink carriers S_{SLCA}), the Tx UE may declare a PC5 RLF. In some aspects, after declaring a PC5 RLF, the Tx UE may report the PC5 RLF to a network node. Reporting the PC5 RLF may include generating an RLF report (also called a sidelink RLF report or a sidelink carrier failure report) and transmitting the RLF report to a network node serving the Tx UE. In some aspects, the Tx UE may not report the sidelink RLF to the network node. For example, if the quantity of candidate sidelink carriers satisfies a threshold, the Tx UE may not report the sidelink RLF to the network node.

As indicated above, FIG. 7 is provided as an example. Other examples may differ from what is described with respect to FIG. 7.

FIG. 8 is a diagram illustrating an example 800 associated with sidelink RLF recovery based on an explicit sidelink carrier failure, in accordance with the present disclosure. The example 800 may be performed by a Tx UE (e.g., UE 120/605) to, for example, detect a PC5 RLF when fewer than a minimum number of sidelink carriers are available based on sidelink carrier selection criteria and in accordance with a timer value.

As shown by reference number 805, the Tx UE may detect a sidelink carrier failure based on one or more indications. The indication of the sidelink RLF may include an indication of reaching a maximum HARQ DTX occurrences (e.g., which may be a defined or configured value for a carrier or for all carriers associated with a sidelink service) at the MAC layer, an indication of reaching a maximum number of retransmissions (e.g., similarly, which may be a defined or configured value for a carrier or for all carriers associated with a sidelink service) at the RLC layer, an indication of integrity check failure at the PDCP layer, or an indication of a timer expiry at the RRC layer for responding a PC5 RRC configuration message. One or more of the indications may be associated with a configuration of the Tx UE, the Rx UE, and/or a combination thereof, among other examples. For example, the indication of the maximum number of retransmission at the RLC layer may be based, at least in part, on a configuration for handling retransmissions of the data logical channel on a carrier selected by MAC (e.g., as described in connection with reference number 810) for ARQ with AM. The indication of the integrity check failure at the PDCP layer may be based, at least in part, on how SRBs are transmitted on a carrier (e.g., SRB2 or SRB3 transmitted on a defined or configured carrier). The indication of the timer expiry at the RRC level may be based, at least in part, on how an RRC message on a control logical channel is transmitted on a carrier selected by MAC (e.g., as described in connection with reference number 810).

As shown by reference number 810, the Tx UE may start a recovery timer and reselect one or more sidelink carriers and update a set of selected sidelink carriers S_{SLCA}. As discussed above, the candidate sidelink carriers may include one or more sidelink carriers available for sidelink communication between the Tx UE and the Rx UE. The one or more sidelink carriers in the set of selected sidelink carriers S_{SCLA} may have been previously selected, by the Tx UE, for sidelink communication with the Rx UE. Accordingly, in some aspects, a reselection of the one or more sidelink carriers may include the Tx UE updating the set of selected sidelink carriers S_{SLCA} with one or more candidate sidelink carriers. The set of selected sidelink carriers S_{SLCA} may be used by the Tx UE for sidelink communications. In some aspects, the carrier associated with the sidelink carrier failure discussed above with respect to reference number 805 may be at least temporarily excluded from the carrier list for carrier selection while the recovery timer is still running. A present value of the timer may be referred to as a “timer value”. For example, for each sidelink carrier configured by upper layers excluding the carrier associated with the sidelink carrier failure on which a sidelink logical channel (e.g., with data available) is allowed, if the CBR of the carrier fails to satisfy (e.g., is below) a threshold for carrier selection associated with the priority of the sidelink logical channel, the carrier is included (by the Tx UE) in the set of selected sidelink carriers S_{SLCA}. In some aspects, the Tx UE may indicate the set of selected sidelink carriers S_{SLCA} to an Rx UE via PC5 RRC message (e.g., for unicast) or to Rx UE(s) via MAC CE and the Rx UE(s) may then monitor the set of selected sidelink carriers S_{SLCA} for sidelink transmissions. In some aspects, the carrier associated with the sidelink carrier failure discussed above with respect to reference number 805 may be added back to the carrier list for carrier selection (e.g., recovered) when the recovery timer expires. In some aspects, the carrier associated with the sidelink carrier failure discussed above with respect to reference number 805 may be added back to the carrier list for carrier selection (e.g., recovered) if the CBR of the carrier is below a threshold for carrier recovery with or without the recovery timer running. In the case that the recovery timer is enabled and is still running, the recovery timer may be stopped based on that the CBR of the carrier is below a threshold for carrier recovery.

As shown by reference number 815, the Tx UE may determine if the set of selected sidelink carriers S_{SLCA} includes a minimum number of sidelink carriers for retaining a PC5 link. The minimum number of sidelink carriers may be a configured or defined quantity. In some aspects, the minimum number of sidelink carriers may be based, at least in part, on a QoS requirement of the PC5 link. For example, for some sidelink communications, one sidelink carrier may be sufficient to meet the QoS requirements. In that case, the minimum number of sidelink carriers may be one. Alternatively, in some aspects, more than one sidelink carrier may be required to meet the QoS requirements (e.g., multiple sidelink carriers are required for PDCP duplication or MAC duplication based on the QoS and/or channel condition). Examples of QoS requirements that may affect the minimum number of sidelink carriers may include data rate, reliability, latency, and/or a combination thereof, among other examples.

As shown by reference number 820, as a result of determining that the minimum number of sidelink carriers are available (e.g., the minimum number of sidelink carriers are included in the set of selected sidelink carriers S_{SLCA}), the Tx UE may continue to transmit sidelink communications using one or more carriers included in the set of selected sidelink carriers S_{SLCA}. For example, for each sidelink logical channel allowed on the carrier where data is available, the Tx UE may select one or more carrier(s) and associated pool(s) of resources from among the set of selected sidelink carriers S_{SLCA} with increasing order of CBR from the lowest CBR for transmitting sidelink communications, among other examples.

As shown by reference number 825, as a result of the Tx UE determining that the minimum number of sidelink carriers are unavailable (e.g., the minimum number of sidelink carriers are not included in the set of selected sidelink carriers S_{SLCA}) to meet the QoS requirements, the Tx UE may determine whether the carrier associated with the sidelink carrier failure (e.g., as detected in connection with reference number 805) has recovered. In some aspects, Tx UE may determine whether the failed carrier has recovered based on if the recovery timer has expired. The expiration of the timer May indicate that the failed carrier (e.g., the carrier associated with the carrier failure indicated in connection with reference number 805) has recovered. The Tx UE may determine that the recovery timer has expired by comparing the recovery timer value to a defined value. If the recovery timer value exceeds the value, the Tx UE may determine that the recovery timer has expired. If the recovery timer value is less than the value, the Tx UE may determine that the recovery timer has not expired. The value may be based, at least in part, on a configuration, a pre-configuration, and/or a combination thereof, among other examples. In some aspects, Tx UE may determine whether the failed carrier is recovered based on if the CBR of the failed carrier is below a threshold for carrier recovery. The threshold value may be based, at least in part, on a configuration, a defined value, and/or a combination thereof, among other examples.

As shown by reference number 830, as a result of determining that the failed carrier has recovered, the Tx UE may perform sidelink carrier reselection. For example, the Tx UE may perform the sidelink reselection similar to the reselection discussed above with respect to reference number 810 except the Tx UE may include the recovered carrier in the set of sidelink candidate carriers for carrier selection or reselection. Further, in some aspects, since the expiration of the recovery timer may indicate that the failed carrier has recovered, the Tx UE may include the previously failed (e.g., now-recovered) carrier for carrier selection or reselection. Accordingly, the set of candidate sidelink carriers and/or the set of selected sidelink carriers S_{SLCA} may include the recovered carrier.

As shown by reference number 835, as a result of determining that the failed carrier has not recovered (e.g., via recovery timer expiry or via CBR measurement), the Tx UE may declare a PC5 RLF. After declaring the PC5 RLF, the Tx UE may report the PC5 RLF. Reporting the PC5 RLF may include generating an RLF report and transmitting the RLF report to a network node serving the Tx UE. In some aspects, the Tx UE may not report the sidelink RLF to the network node. For example, if the quantity of candidate sidelink carriers satisfies a threshold, the Tx UE may not report the sidelink RLF to the network node.

As indicated above, FIG. 8 is provided as an example. Other examples may differ from what is described with respect to FIG. 8.

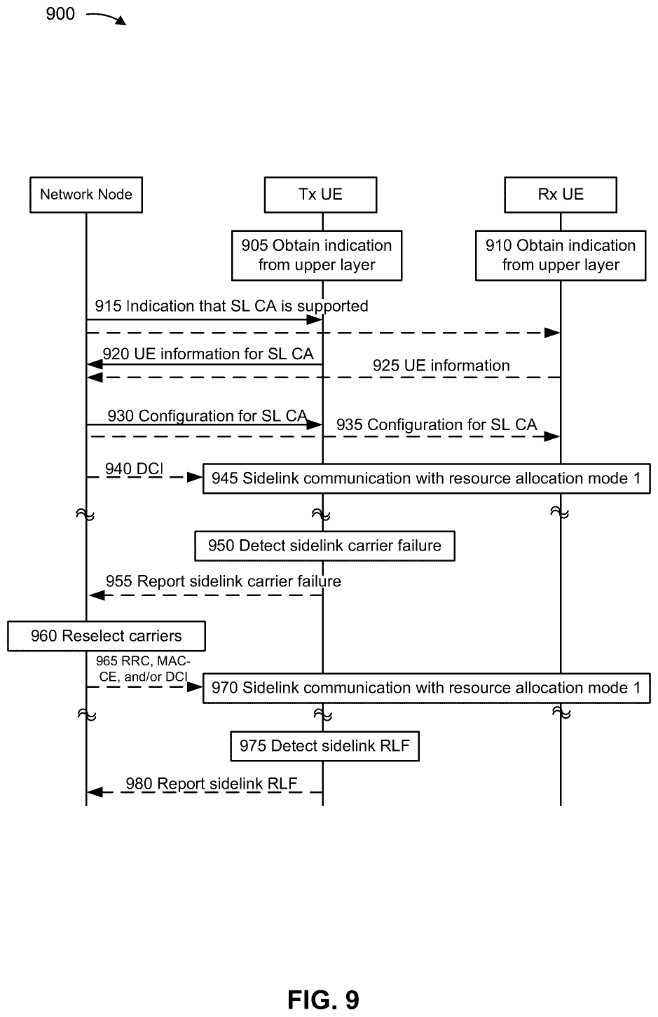

FIG. 9 is a diagram of an example 900 associated with sidelink RLF detection and recovery involving a network node, in accordance with the present disclosure. As shown in FIG. 9, a network node (e.g., network node 110, a CU, a DU, and/or an RU) may communicate with a Tx UE (e.g., UE 120/605) and an Rx UE (e.g., UE 120/610) via a Uu interface, and the Tx UE and the Rx UE (e.g., UE 120/610) may communicate with one another via sidelink. In some aspects, the network node and the UEs may be part of a wireless network (e.g., wireless network 100). The UEs and the network node may have established a wireless connection prior to operations shown in FIG. 9.

As shown by reference number 905, the Tx UE may receive an upper-layer indication (e.g., sl-txcc-list1 or sl-txcc-list2) indicating the multiple sidelink carriers (e.g., one or more sidelink carriers associated with the PC5 QoS flow(s) or QoS profile(s) corresponding to one or more services on a PC5 connection) may be used for transmission or reception for a sidelink communication. In some aspects, the indication may also include the minimum number of required carriers for sidelink communication or the PC5 connection based on QoS requirement. In some aspects, the UE may determine the minimum number of required carriers for sidelink communication or the PC5 connection based on QoS requirement and indicate the minimum number of required carriers to the other UE (e.g., Rx UE).

As shown by reference number 910, the Rx UE may receive an upper-layer indication (e.g., sl-rxcc-list1 or sl-rxcc-list2) indicating the multiple sidelink carriers (e.g., one or more sidelink carrier associated with the PC5 QoS flow(s) or QoS profile(s) corresponding to one or more services on a PC5 connection) may be used for transmission or reception for a sidelink communication. In some aspects, the indication may also include the minimum number of required carriers for sidelink unicast or the PC5 connection. In some aspects, the UE may determine the minimum number of required carriers for sidelink communication or the PC5 connection based on QoS requirement and indicate the minimum number of required carriers to the other UE (e.g., Tx UE).

As shown by reference number 915, the Tx UE and the Rx UE (if the Rx UE is under the coverage of the network node) may receive, and the network node may transmit, an indication of that sidelink carrier aggregation is supported. For example, the Tx UE and/or the Rx UE may monitor a system information block (SIB) broadcasted by the network node. The SIB (e.g., SIB24) may indicate whether the network node supports sidelink carrier aggregation via, for example, an implicit indication with a list of sidelink carriers supported or an explicit indication (e.g., a flag) for sidelink carrier aggregation.

As shown by reference number 920, the Tx UE may transmit information for sidelink carrier aggregation to the network node (e.g., UE capability with sidelink carrier aggregation and/or preferred sidelink carrier aggregation parameters). For example, the Tx UE may transmit a sidelink UE information message to the network node indicating supported sidelink carrier lists (e.g., indicated from the upper layer for a sidelink communication), cast types, destination IDs, QoS profiles, the minimum number of required carriers, and/or a combination thereof, among other examples.

As shown by reference number 925, the Rx UE may transmit UE information for sidelink carrier aggregation to the network node (e.g., UE capability with sidelink carrier aggregation and/or preferred sidelink carrier aggregation parameters). For example, the Rx UE may transmit a sidelink information message to the Tx UE indicating supported sidelink carrier lists (e.g., received from the upper layer for a sidelink communication), the maximum or minimum number of supported carriers, and/or a combination thereof, among other examples. Furthermore, the Tx UE may include the received UE information (from the Rx UE) in the sidelink UE information message to the network as described in the connection with the reference number 920.

As shown by reference number 930, the network node may transmit, and the Tx UE may receive, a configuration for the sidelink communication using sidelink carrier aggregation. The configuration may be based, at least in part, on the information transmitted by the Tx UE, discussed above with respect to reference number 920. For example, in some aspects, the configuration may be based, at least in part, on the information associated with the destination ID (e.g., identifying the sidelink communication from the Tx UE to the Rx UE), a sidelink carrier list for sidelink carrier aggregation, resource pools for each carrier, a recovery time value for sidelink carrier recovery, one or more resource configuration for resource allocation mode 1 with type 1 configured grants, and/or a combination thereof, among other examples.

As shown by reference number 935, the Tx UE may forward, and the Rx UE may receive, the configuration for the sidelink communication using sidelink carrier aggregation, wherein the configuration is transmitted by the network node at reference number 930. In some aspects, the Tx UE may forward the configuration to the Rx UE if the Rx UE is outside a range of the network node. In some aspects, Tx UE may determine a configuration for the sidelink communication using sidelink carrier aggregation based on the UE information received from the Rx UE (e.g., when Tx UE and Rx UE are out of the network's coverage or when Tx UE operates with resource allocation mode 2) and transmit the determined configuration to the Rx UE (e.g., a sidelink carrier list for sidelink carrier aggregation, etc.).

In some aspects, the Tx UE and/or the Rx UE may receive the configuration information discussed above with respect to reference numbers 930 and 935, respectively, in accordance with one or more of system information (e.g., a master information block (MIB) and/or an SIB, among other examples), RRC signaling, one or more MAC control elements (CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the Tx UE and/or the Rx UE are to perform the process 700 discussed above with respect to FIG. 7 or the process 800 discussed above with respect to FIG. 8. The Tx UE and/or the Rx UE may configure themselves based at least in part on the configuration information. In some aspects, the Tx UE and/or Rx UE may be configured to perform one or more operations described herein based at least in part on the configuration information.

As shown by reference number 940, the network node may transmit, and the Tx UE may receive, DCI activating the sidelink resources for resource allocation mode 1 with a type 2 configured grant or DCI indicating a dynamic grant for the sidelink communication on a carrier indicated in DCI. In some aspects, such as when the Tx UE is configured with a type 1 configured grant, the Tx UE may transmit the sidelink communication without DCI activating a type 2 configured grant or indicating a dynamic grant.

As shown by reference number 945, the Tx UE and the Rx UE may communicate via sidelink in accordance with a mode 1 resource allocation based, at least in part, on the resources configured via the received configuration for a type 1 sidelink configured grant, the resources activated via the DCI for a type 2 sidelink configured grant, the resources granted in the received DCI for a dynamic grant, and/or a combination thereof, among other examples.

As shown by reference number 950, the Tx UE may detect a sidelink carrier failure. For example, the sidelink carrier failure may be detected via one or more indications such as the indications discussed above with respect to the example 700 of FIG. 7 (e.g., reference number 705), the example 800 of FIG. 8 (e.g., reference number 805), and/or a combination thereof, among other examples.

As shown by reference number 955, the Tx UE may report the sidelink carrier failure to the network node. For example, the Tx UE may transmit an uplink signal over the Uu interface reporting the sidelink carrier failure (e.g., a MAC CE indicating the failed carrier(s) using carrier index or carrier bitmap). In some aspects, the Tx UE may not report the sidelink carrier failure to the network node. For example, if the quantity of candidate sidelink carriers satisfies a threshold, the Tx UE may not report the sidelink carrier failure to the network node. Accordingly, in some aspects, reporting the sidelink carrier failure (e.g., transmitting the sidelink carrier failure report by the Tx UE and reporting the sidelink carrier failure report at the network node) may be optional.

As shown by reference number 960, the network node may reselect the sidelink carriers. For example, the network node may perform one or more processes similar to those detailed above with respect to reference numbers 710 and/or 715 of FIG. 7, reference numbers 810, 815, and/or 825 of FIG. 8, and/or a combination thereof, among other examples. For example, in some aspects, the network node may use information contained in a sidelink carrier failure report transmitted from the Tx UE to the network node. In some aspects, the sidelink carrier failure report may indicate, to the network node, the sidelink carrier failure. In some aspects, the sidelink carrier failure report may indicate which of the one or more sidelink carriers has failed. The network node may use the information included in the sidelink carrier failure report to reselect the one or more sidelink carriers. In some aspects, such as if the sidelink carrier failure report is not transmitted by the Tx UE, the network node may reselect the sidelink carriers without receiving the sidelink carrier failure report.

As shown by reference number 965, the network node may transmit an RRC configuration with one or more reselected carrier(s) for resource allocation mode 1 with configured grant type 1, MAC CE activating the reselected sidelink carrier(s), or DCI activating resources with the reselected sidelink carrier(s) for resource allocation mode 1 with configured grant type 2, or DCI indicating a dynamic grant with the reselected sidelink carrier(s).

As shown by reference number 970, the Tx UE and the Rx UE may communicate via sidelink in accordance with a mode 1 resource allocation and the reselected carriers.

As shown by reference number 975, the Tx UE may detect a sidelink RLF. For example, the sidelink RLF may be detected via one or more indications such as the indications discussed above with respect to the example 700 of FIG. 7 (e.g., reference number 725), the example 800 of FIG. 8 (e.g., reference number 835), and/or a combination thereof, among other examples. In some aspects, the Tx UE may not report the sidelink RLF to the network node. For example, if the quantity of candidate sidelink carriers satisfies a threshold, the Tx UE may not report the sidelink RLF to the network node.

As shown by reference number 980, the Tx UE may report the subsequent sidelink RLF to the network node. For example, the Tx UE may transmit an uplink signal (e.g., a MAC CE) over the Uu interface reporting the sidelink RLF. The network node may release the configuration or resource allocation to the sidelink communication associated to the destination ID.

As indicated above, FIG. 9 is provided as an example. Other examples may differ from what is described with respect to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with sidelink RLF detection and recovery.

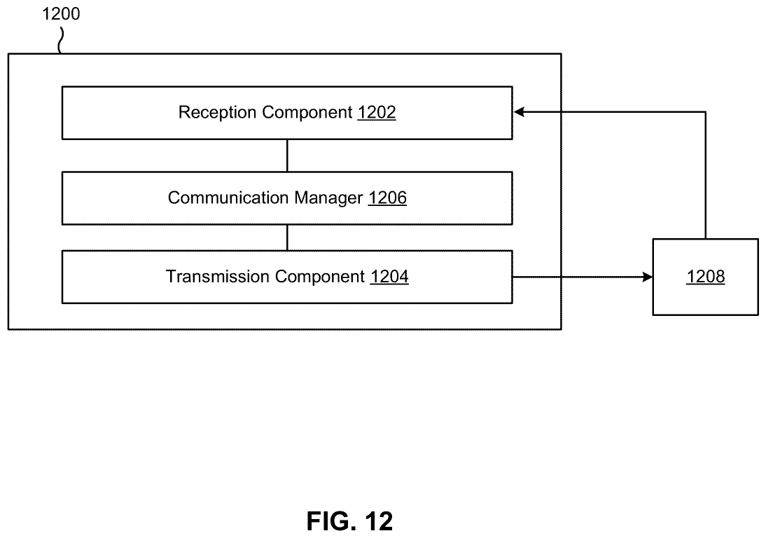

As shown in FIG. 10, in some aspects, process 1000 may include receiving a sidelink carrier aggregation configuration including a configuration for sidelink RLF detection to: select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers (block 1010). For example, the UE (e.g., using reception component 1202 and/or communication manager 1206, depicted in FIG. 12) may receive a sidelink carrier aggregation configuration including a configuration for sidelink RLF detection to: select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers, as described above.

As further shown in FIG. 10, in some aspects, process 1000 may include transmitting a sidelink communication in accordance with the one or more sidelink carriers (block 1020). For example, the UE (e.g., using transmission component 1204 and/or communication manager 1206, depicted in FIG. 12) may transmit a sidelink communication in accordance with the one or more sidelink carriers, as described above.

Process 1000 may include additional aspects, such as any single aspect or any combination of aspects described below and/or in connection with one or more other processes described elsewhere herein.

In a first aspect, process 1000 includes detecting a sidelink RLF as a result of a failed attempt to recover from the sidelink carrier failure.

In a second aspect, alone or in combination with the first aspect, an indication of the sidelink carrier failure includes one or more of a maximum discontinuous transmission, a maximum quantity of retransmissions, an integrity check failure, or a timer expiration.

In a third aspect, alone or in combination with one or more of the first and second aspects, the one or more candidate sidelink carriers includes the failed sidelink carrier.

In a fourth aspect, alone or in combination with one or more of the first through third aspects, the one or more candidate sidelink carriers excludes the failed sidelink carrier.

In a fifth aspect, alone or in combination with one or more of the first through fourth aspects, the configuration for sidelink RLF detection further includes one or more configurations for setting a timer for an amount of time, and excluding the failed sidelink carrier from among the one or more candidate sidelink carriers until the amount of time has elapsed.

In a sixth aspect, alone or in combination with one or more of the first through fifth aspects, the configuration for sidelink RLF detection further includes one or more configurations for transmitting, to a network node, a sidelink carrier failure report identifying the failed sidelink carrier.

In a seventh aspect, alone or in combination with one or more of the first through sixth aspects, the configuration for sidelink RLF detection further includes one or more configurations for comparing a quantity of the one or more candidate sidelink carriers to a threshold, and transmitting a sidelink RLF report, wherein the sidelink RLF report is transmitted as a result of the quantity of the one or more candidate sidelink carriers failing to satisfy the threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with sidelink RLF detection and recovery.

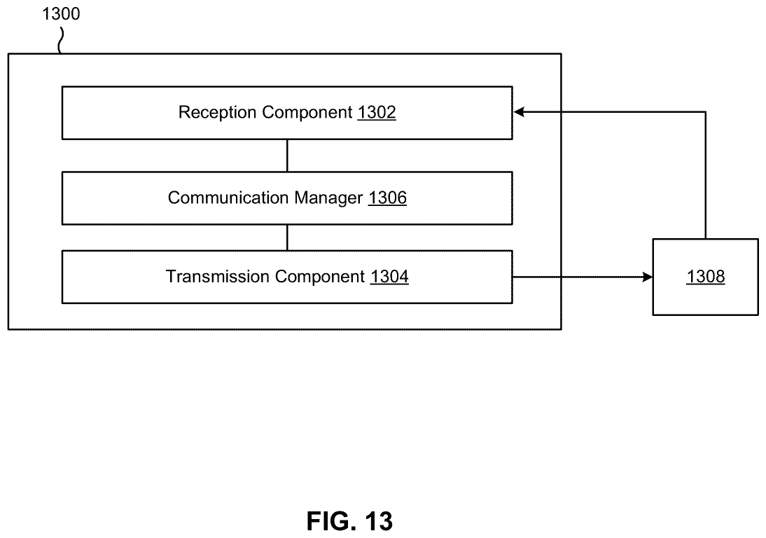

As shown in FIG. 11, in some aspects, process 1100 may include outputting, to a UE, a sidelink carrier aggregation configuration including a configuration for sidelink RLF detection (block 1110). For example, the network node (e.g., using transmission component 1304 and/or communication manager 1306, depicted in FIG. 13) may output, to a UE, a sidelink carrier aggregation configuration including a configuration for sidelink RLF detection, as described above.

As further shown in FIG. 11, in some aspects, process 1100 may include receiving a sidelink carrier failure report identifying a failed sidelink carrier (block 1120). For example, the network node (e.g., using reception component 1302 and/or communication manager 1306, depicted in FIG. 13) may receive a sidelink carrier failure report identifying a failed sidelink carrier, as described above.

As further shown in FIG. 11, in some aspects, process 1100 may include outputting a downlink signal identifying a sidelink carrier from among one or more available sidelink carriers in accordance with the sidelink carrier failure report (block 1130). For example, the network node (e.g., using transmission component 1304 and/or communication manager 1306, depicted in FIG. 13) may output a downlink signal identifying a sidelink carrier from among one or more available sidelink carriers in accordance with the sidelink carrier failure report, as described above. The process 1100 of FIG. 11 performed by the network node is not necessarily reciprocated by corresponding steps performed by the UE, as above described in the process 1000 of FIG. 10.

Process 1100 may include additional aspects, such as any single aspect or any combination of aspects described below and/or in connection with one or more other processes described elsewhere herein.

In a first aspect, the one or more available sidelink carriers includes the failed sidelink carrier.

In a second aspect, alone or in combination with the first aspect, the one or more available sidelink carriers excludes the failed sidelink carrier.

In a third aspect, alone or in combination with one or more of the first and second aspects, the configuration for sidelink RLF detection includes a timer value.

In a fourth aspect, alone or in combination with one or more of the first through third aspects, the downlink signal identifying a sidelink carrier is output in response to receiving the sidelink carrier failure report.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-11. Additionally, or alternatively, the apparatus 1200 may be configured to perform one or more processes described herein, such as process 700 of FIG. 7, process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a sidelink carrier aggregation configuration including a configuration for sidelink RLF detection to select one or more sidelink carriers, detect a sidelink carrier failure associated with a failed sidelink carrier from among the one or more sidelink carriers, and recover from the sidelink carrier failure in accordance with a reselection of at least one of the one or more sidelink carriers from among one or more candidate sidelink carriers. The transmission component 1204 may transmit a sidelink communication in accordance with the one or more sidelink carriers. The communication manager 1206 may detect a sidelink RLF as a result of a failed attempt to recover from the sidelink carrier failure. The reception component 1202 may receive a downlink signal identifying a sidelink carrier in accordance with the sidelink carrier failure report.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-11. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1302 and/or the transmission component 1304 may include or May be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may output, to a UE, a sidelink carrier aggregation configuration including a configuration for sidelink RLF detection. The reception component 1302 may receive a sidelink carrier failure report identifying a failed sidelink carrier. The transmission component 1304 may output a downlink signal identifying a sidelink carrier from among one or more available sidelink carriers in accordance with the sidelink carrier failure report.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving a sidelink carrier aggregation configuration including a configuration for sidelink RLF detection by: selecting one or more sidelink carriers, detecting a sidelink carrier failure associated with a failed sidelink carrier from among the one or more sidelink carriers, and recovering from the sidelink carrier failure in accordance with a reselection of at least one of the one or more sidelink carriers from among one or more candidate sidelink carriers; and transmitting a sidelink communication in accordance with the one or more sidelink carriers.

Aspect 2: The method of Aspect 1, further comprising detecting a sidelink RLF as a result of a failed attempt to recover from the sidelink carrier failure.

Aspect 3: The method of any of Aspects 1-2, wherein an indication of the sidelink carrier failure includes one or more of: a maximum discontinuous transmission; a maximum quantity of retransmissions; an integrity check failure; or a timer expiration.

Aspect 4: The method of any of Aspects 1-3, wherein the one or more candidate sidelink carriers includes the failed sidelink carrier.

Aspect 5: The method of any of Aspects 1-4, wherein the one or more candidate sidelink carriers excludes the failed sidelink carrier.

Aspect 6: The method of any of Aspects 1-5, wherein the configuration for sidelink RLF detection further includes one or more configurations for: setting a timer for an amount of time, and excluding the failed sidelink carrier from among the one or more candidate sidelink carriers until the amount of time has elapsed.

Aspect 7: The method of any of Aspects 1-6, wherein the configuration for sidelink RLF detection further includes one or more configurations for transmitting, to a network node, a sidelink carrier failure report identifying the failed sidelink carrier.

Aspect 8: The method of Aspect 7, wherein the configuration for sidelink RLF detection further includes one or more configurations for: comparing a quantity of the one or more candidate sidelink carriers to a threshold; and transmitting a sidelink RLF report, wherein the sidelink RLF report is transmitted as a result of the quantity of the one or more candidate sidelink carriers failing to satisfy the threshold.

Aspect 9: The method of Aspect 8, further comprising receiving a downlink signal identifying a sidelink carrier in accordance with the sidelink RLF report.

Aspect 10: A method of wireless communication performed by a network node, comprising: outputting, to a UE, a sidelink carrier aggregation configuration including a configuration for sidelink RLF detection; receiving a sidelink carrier failure report identifying a failed sidelink carrier; and outputting a downlink signal identifying a sidelink carrier from among one or more available sidelink carriers in accordance with the sidelink carrier failure report.

Aspect 11: The method of Aspect 10, wherein the one or more available sidelink carriers includes the failed sidelink carrier.

Aspect 12: The method of any of Aspects 10-11, wherein the one or more available sidelink carriers excludes the failed sidelink carrier.

Aspect 13: The method of any of Aspects 10-12, wherein the configuration for sidelink RLF detection includes a timer value.

Aspect 14: The method of any of Aspects 10-13, wherein the downlink signal identifying a sidelink carrier is output in response to receiving the sidelink carrier failure report.

Aspect 15: An apparatus for wireless communication at a device, the apparatus comprising one or more processors; one or more memories coupled with the one or more processors; and instructions stored in the one or more memories and executable by the one or more processors individually or collectively to cause the apparatus to perform the method of one or more of Aspects 1-14.

Aspect 16: An apparatus for wireless communication at a device, the apparatus comprising one or more memories and one or more processors coupled to the one or more memories, the one or more processors individually or collectively configured to cause the device to perform the method of one or more of Aspects 1-14.

Aspect 17: An apparatus for wireless communication, the apparatus comprising at least one means for performing the method of one or more of Aspects 1-14.

Aspect 18: A non-transitory computer-readable medium storing code for wireless communication, the code comprising instructions executable by one or more processors to perform the method of one or more of Aspects 1-14.

Aspect 19: A non-transitory computer-readable medium storing a set of instructions for wireless communication, the set of instructions comprising one or more instructions that, when executed individually or collectively by one or more processors of a device, cause the device to perform the method of one or more of Aspects 1-14.

Aspect 20: A device for wireless communication, the device comprising a processing system that includes one or more processors and one or more memories coupled with the one or more processors, the processing system configured to cause the device to perform the method of one or more of Aspects 1-14.

Aspect 21: An apparatus for wireless communication at a device, the apparatus comprising one or more memories and one or more processors coupled to the one or more memories, the one or more processors individually or collectively configured to cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, the one or more processors individually or collectively configured to cause the UE to:
receive a sidelink carrier aggregation configuration including a configuration for sidelink radio link failure (RLF) detection to:
select one or more sidelink carriers;
detect a sidelink carrier failure associated with a failed sidelink carrier from among the one or more sidelink carriers, and
recover from the sidelink carrier failure in accordance with a reselection of at least one of the one or more sidelink carriers from among one or more candidate sidelink carriers; and
transmit a sidelink communication in accordance with the one or more sidelink carriers.

2. The UE of claim 1, wherein the one or more processors are further individually or collectively configured to cause the UE to detect a sidelink RLF as a result of a failed attempt to recover from the sidelink carrier failure.

3. The UE of claim 1, wherein an indication of the sidelink carrier failure includes one or more of:
a maximum discontinuous transmission;
a maximum quantity of retransmissions;
an integrity check failure; or
a timer expiration.

4. The UE of claim 1, wherein the one or more candidate sidelink carriers includes the failed sidelink carrier.

5. The UE of claim 1, wherein the one or more candidate sidelink carriers excludes the failed sidelink carrier.

6. The UE of claim 1, wherein the configuration for sidelink RLF detection further includes one or more configurations for:
setting a timer for an amount of time, and
excluding the failed sidelink carrier from among the one or more candidate sidelink carriers until the amount of time has elapsed.

7. The UE of claim 1, wherein the configuration for sidelink RLF detection further includes one or more configurations for transmitting, to a network node, a sidelink carrier failure report identifying the failed sidelink carrier.

8. The UE of claim 7, wherein the configuration for sidelink RLF detection further includes one or more configurations for:
comparing a quantity of the one or more candidate sidelink carriers to a threshold; and
transmitting a sidelink RLF report,
wherein the sidelink RLF report is transmitted as a result of the quantity of the one or more candidate sidelink carriers failing to satisfy the threshold.

9. The UE of claim 8, wherein the one or more processors are further individually or collectively configured to cause the UE to receive a downlink signal identifying a sidelink carrier in accordance with the sidelink RLF report.

10. A network node for wireless communication, comprising:
one or more memories; and
one or more processors, coupled to the one or more memories, the one or more processors individually or collectively configured to cause the network node to:
output, to a user equipment (UE), a sidelink carrier aggregation configuration including a configuration for sidelink radio link failure (RLF) detection;
receive a sidelink carrier failure report identifying a failed sidelink carrier; and
output a downlink signal identifying a sidelink carrier from among one or more available sidelink carriers in accordance with the sidelink carrier failure report.

11. The network node of claim 10, wherein the one or more available sidelink carriers includes the failed sidelink carrier.

12. The network node of claim 10, wherein the one or more available sidelink carriers excludes the failed sidelink carrier.

13. The network node of claim 10, wherein the configuration for sidelink RLF detection includes a timer value.

14. The network node of claim 10, wherein the downlink signal identifying a sidelink carrier is output in response to receiving the sidelink carrier failure report.

15. A method of wireless communication performed by a user equipment (UE), comprising:
receiving a sidelink carrier aggregation configuration including a configuration for sidelink radio link failure (RLF) detection by:
selecting one or more sidelink carriers,
detecting a sidelink carrier failure associated with a failed sidelink carrier from among the one or more sidelink carriers, and
recovering from the sidelink carrier failure in accordance with a reselection of at least one of the one or more sidelink carriers from among one or more candidate sidelink carriers; and
transmitting a sidelink communication in accordance with the one or more sidelink carriers.

16. The method of claim 15, further comprising detecting a sidelink RLF as a result of a failed attempt to recover from the sidelink carrier failure.

17. The method of claim 15, wherein an indication of the sidelink carrier failure includes one or more of:
a maximum discontinuous transmission;
a maximum quantity of retransmissions;
an integrity check failure; or
a timer expiration.

18. The method of claim 15, wherein the one or more candidate sidelink carriers includes the failed sidelink carrier.

19. The method of claim 15, wherein the one or more candidate sidelink carriers excludes the failed sidelink carrier.

20. The method of claim 15, wherein the configuration for sidelink RLF detection further includes one or more configurations for:
setting a timer for an amount of time, and
excluding the failed sidelink carrier from among the one or more candidate sidelink carriers until the amount of time has elapsed.

21. The method of claim 15, wherein the configuration for sidelink RLF detection further includes one or more configurations for transmitting, to a network node, a sidelink carrier failure report identifying the failed sidelink carrier.

22. The method of claim 21, wherein the configuration for sidelink RLF detection further includes one or more configurations for:
comparing a quantity of the one or more candidate sidelink carriers to a threshold; and
transmitting a sidelink RLF report,
wherein the sidelink RLF report is transmitted as a result of the quantity of the one or more candidate sidelink carriers failing to satisfy the threshold.

23. The method of claim 22, further comprising receiving a downlink signal identifying a sidelink carrier in accordance with the sidelink RLF report.

24. A method of wireless communication performed by a network node, comprising:
outputting, to a user equipment (UE), a sidelink carrier aggregation configuration including a configuration for sidelink radio link failure (RLF) detection;
receiving a sidelink carrier failure report identifying a failed sidelink carrier; and
outputting a downlink signal identifying a sidelink carrier from among one or more available sidelink carriers in accordance with the sidelink carrier failure report.

25. The method of claim 24, wherein the one or more available sidelink carriers includes the failed sidelink carrier.

26. The method of claim 24, wherein the one or more available sidelink carriers excludes the failed sidelink carrier.

27. The method of claim 24, wherein the configuration for sidelink RLF detection includes a timer value.

28. The method of claim 24, wherein the downlink signal identifying a sidelink carrier is output in response to receiving the sidelink carrier failure report.
